(19) United States
(12) Patent Application Publication
(10) Pub. No.: US 2026/0094855 A1
(43) Pub. Date: Apr. 2, 2026

(54) STEEL PRISMATIC CAN CONSTRUCTION FOR IMPROVED THERMAL EFFICIENCY

(71) Applicant: GM GLOBAL TECHNOLOGY OPERATIONS LLC, Detroit, MI (US)

(72) Inventors: Diptak Bhattacharya, Royal Oak, MI (US); Junjie Ma, Novi, MI (US); Xiaoling Chen, Sterling Heights, MI (US); Ryan Patrick Hickey, Austin, TX (US); Andrew Clay Bobel, Troy, MI (US); William Yu Chen, Troy, MI (US); Blair E. Carlson, Ann Arbor, MI (US); Matthew Arthur Celentano, Berkley, MI (US); Masoud Mohammadpour, Novi, MI (US)

(21) Appl. No.: 18/898,952

(22) Filed: Sep. 27, 2024

(51) Int. Cl. H01M 10/04; H01M 50/103; H01M 50/119; H01M 50/15; H01M 50/30; H01M 50/536

(52) U.S. Cl. CPC H01M 10/04; H01M 50/103; H01M 50/119; H01M 50/15; H01M 50/30; H01M 50/536; H01M 2200/20

(57) ABSTRACT

A battery includes a prismatic cell can formed from steel. The prismatic cell can includes a first end, a second end spaced from the first end, a top surface, a bottom surface, a first side surface, and a second side surface that define a hollow can cavity. An anode current collector includes an anode foil tab. A cathode current collector includes a cathode foil tab. An anode terminal lead is secured to the anode foil tab. A cathode terminal lead is secured to the cathode foil tab. The anode current collector and the cathode current collector form an electrode stack arranged in the hollow can cavity with the anode terminal lead being connected to the bottom surface of the prismatic cell can forming a direct thermal pathway through the electrode stack to the bottom surface.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery assemblies and, more particularly, to a battery assembly including prismatic can enclosure formed from steel.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators arranged in a battery cell stack located in a battery cell enclosure (or cell can). The cathode electrodes include a cathode active material layer arranged on a cathode current collector. The anode electrodes include an anode active material layer arranged on an anode current collector. The cathode and anode electrodes are connected to cathode and anode terminals arranged on an outer surface of the enclosure.

Batteries or battery packs typically include a cell can that supports and surrounds the battery cells. The terminals of the battery cells are connected to corresponding terminals on the cell can. Batteries are then arranged in a housing and interconnected to provide a desired output voltage. Generally, the batteries rest on a cold plate that absorbs and removes heat from the battery cells.

### SUMMARY

A battery, in accordance with the present disclosure, includes a prismatic cell can formed from steel. The prismatic cell can includes a first end, a second end spaced from the first end, a top surface, a bottom surface, a first side surface, and a second side surface. The top surface, bottom surface, first side surface and the second side surface define a hollow can cavity. An anode current collector is arranged in the hollow can cavity. The anode current collector includes a top surface portion, a bottom surface portion, and an anode foil tab projecting outwardly from one of the top surface portion and the bottom surface portion. A cathode current collector is arranged in the hollow can cavity. The cathode current collector includes a top surface section, a bottom surface section, and a cathode foil tab projecting outwardly from one of the top surface section and the bottom surface section. An anode terminal lead extends over the one of the top surface portion and the bottom surface portion of the anode current collector. The anode terminal lead is secured to the anode foil tab. A cathode terminal lead extends over the one of the top surface section and the bottom surface section of the cathode current collector. The cathode terminal lead is secured to the cathode foil tab. The anode current collector and the cathode current collector form an electrode stack arranged in the hollow can cavity with the anode terminal lead being connected to the bottom surface of the prismatic cell can forming a direct thermal pathway through the electrode stack to the bottom surface.

In other features, a first cap plate is mounted at the first end of the prismatic cell can and a second cap plate is mounted at the second end of the prismatic cell can.

In other features, the anode terminal lead is electrically secured to the first cap plate and the cathode terminal lead is electrically secured to the second cap plate.

In other features, a vent is formed in one of the first cap plate and the second cap plate.

In other features, a first fin is formed on the first cap plate and a second fin is formed on the second cap plate, the first fin engaging the electrode stack at the first end of the prismatic cell can and the second fin engaging the electrode stack at the second end of the prismatic cell can.

In other features, the electrode stack includes a plurality of anode current collectors and a plurality of anode foil tabs and a plurality of cathode current collectors and a plurality of a cathode foil tabs.

In other features, the anode current collector includes a plurality of anode foil tabs, and the cathode current collector includes a plurality of cathode foil tabs.

A method of forming a battery includes forming a prismatic cell can from steel including a first end, a second end spaced from the first end, a top surface, a bottom surface, a first side surface, and a second side surface, the top surface, bottom surface, first side surface and the second side surface defining an hollow can cavity, forming an electrode stack including an anode current collector having a top surface portion and a bottoms surface portion and a cathode current collector having a top surface section and a bottom surface section, folding an anode foil tab over one of the top surface portion and the bottoms surface portion, folding a cathode foil tab over one of the top surface section and the bottom surface section, connecting an anode terminal lead to the anode foil tab, the anode terminal lead extending over the one of the top surface portion and the bottom surface portion, connecting a cathode terminal lead to the cathode foil tab, the cathode terminal lead extending over the one of the top surface section and the bottom surface section, inserting the electrode stack into the hollow can cavity with the anode terminal lead being in electrical contact with the bottom surface, and connecting the anode terminal lead to the bottom surface creating a direct thermal pathway through the electrode stack to the bottom surface.

In other features, connecting a first cap plate to the anode terminal lead and connecting a second cap plate to the cathode terminal lead.

In other features, the first cap plate is secured to the first end of the prismatic cell can and the second cap plate is secured to the second end of the prismatic cell can.

In other features, a gap is maintained between the top surface of the prismatic cell can and the top surface portion of the anode current collector and the top surface section of the cathode current collector.

In other features, the electrode stack is supported on an insertion fixture.

In other features, inserting the electrode stack into the hollow can cavity includes sliding the insertion fixture along the top surface of the prismatic cell can with the anode terminal lead.

In other features, connecting the anode terminal lead to the bottom surface of the prismatic can cell includes removing an air gap between the bottom surface and the anode terminal lead with the electrode stack supported on the insertion fixture.

In other features, the insertion fixture is removed from the prismatic cell can after connecting the anode terminal to the bottom surface.

In other features, supporting the electrode stack on the insertion fixture includes resting the electrode stack on a tray having a selected thickness.

In other features, supporting the electrode stack on the insertion fixture includes mounting a first U-shaped end cap to a first end of the electrode stack and mounting a second U-shaped end cap to a second end of the electrode stack.

In other features, inserting the electrode stack into the hollow can cavity includes forming a prismatic cell can form about the electrode stack to form the prismatic cell can.

In other features, forming the prismatic cell can form about the electrode stack includes welding the anode terminal lead to a surface of a prismatic cell can form.

In other features, forming the prismatic cell can form about the electrode stack includes folding a first side of the prismatic cell can form to the first side surface and a first portion of the top surface and folding a second side of the prismatic cell can form to form the second side surface and a second portion of the top surface.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a front elevational view of a plurality of batteries each including a prismatic cell can, formed in accordance with the present disclosure, resting on a cold plate;

FIG. 2 is a perspective view of one of the plurality of batteries of FIG. 1, in accordance with a non-limiting example;

FIG. 3 is a perspective view of a prismatic cell can formed from steel, in accordance with a non-limiting example;

FIG. 4 is a perspective view of an anode electrode having a notched anode foil tab and a cathode electrode having a notched cathode foil tab, in accordance with a non-limiting example;

FIG. 5 is a perspective view of an anode electrode having a notched anode foil tab and a cathode electrode having a notched cathode foil tab, in accordance with another aspect of the non-limiting example;

FIG. 6 is a perspective view of an anode electrode having a notched anode foil tab and a cathode electrode having a notched cathode foil tab, in accordance with yet another non-limiting example;

FIG. 7 depicts an electrode stack including anode foil tabs folded over a top surface of the anode electrode and the cathode electrode and the cathode foil tab folded under a bottom surface of the anode electrode and the cathode electrode, in accordance with a non-limiting example;

FIG. 8 depicts an anode terminal lead connected to the anode foil tab and a cathode terminal lead connected to the cathode foil tab, in accordance with a non-limiting example;

FIG. 9 depicts an anode terminal lead and a cathode terminal lead in accordance with another non-limiting example;

FIG. 10 depicts an anode terminal lead and a cathode terminal lead in accordance with yet another non-limiting example;

FIG. 11 depicts the electrode stack of FIG. 8 mounted on an insertion fixture, in accordance with a non-limiting example;

FIG. 12 depicts insertion of the electrode stack of FIG. 11 into the prismatic cell can of FIG. 3, in accordance with a non-limiting example;

FIG. 13 depicts welding the anode terminal lead to a top surface of the prismatic cell can, in accordance with a non-limiting example;

FIG. 14A depicts connecting a first end cap to the anode terminal lead and connecting a second end cap to the cathode terminal lead after the cell stack is inserted into the prismatic cell can of FIG. 3, in accordance with a non-limiting example;

FIG. 14B depicts connecting the first end cap and the second end cap to the prismatic cell can, in accordance with a non-limiting example;

FIG. 15 depicts U-shaped end caps mounted to opposing ends of the electrode stack of FIG. 8, in accordance with a non-limiting example;

FIG. 16 depicts insertion of the electrode stack of FIG. 15 into the prismatic cell can of FIG. 3, in accordance with a non-limiting example;

FIG. 17 depicts welding the anode terminal lead of the electrode cell stack of FIG, 16 to a top surface of the prismatic cell can, in accordance with a non-limiting example;

FIG. 18A depicts welding a cell stack to an inner surface of a prismatic cell can form, in accordance with a non-limiting example;

FIG. 18B depicts folding the prismatic cell can form about the cell stack of FIG. 18A, in accordance with a non-limiting example; and

FIG. 18C depicts sealing the cell prismatic cell can about the cell stack of FIG. 18B, in accordance with a non-limiting example.

In the drawings, reference numbers may be reused to identify similar and/or identical elements.

### DETAILED DESCRIPTION

Prismatic can batteries include a cell can having a top surface, a bottom surface, and side surfaces. An electrode stack is arranged within the prismatic cell. The electrode stack may be immersed in an electrolyte. The electrode stack includes foil tabs connected to terminals on the prismatic cell can.

The prismatic batteries are arranged in a housing and interconnected to establish a desired output voltage. The batteries are exposed to a number of charging and discharging cycles. For example, if the battery forms part of an electric vehicle battery, a discharge cycle occurs when the vehicle is under power or in motion. The nature of the discharge cycle will vary depending on driving conditions. The charging cycle typically takes place when the vehicle is at rest. However, charging may also take place during breaking.

During the charging and discharging cycles, heat is generated in the electrode stack. For this reason, the cell can is typically supported on a cold plate in the housing. The cold plate draws heat out of the electrode stack through the prismatic can walls. Given that there is no direct contact between the electrode stack and the bottom surface of the prismatic can, heat conduction typically occurs through the side surfaces. Accordingly, the prismatic can is typically formed from a material having a high thermal conductivity such as aluminum. With this construction, the heat more readily flows through the side walls to the bottom surface.

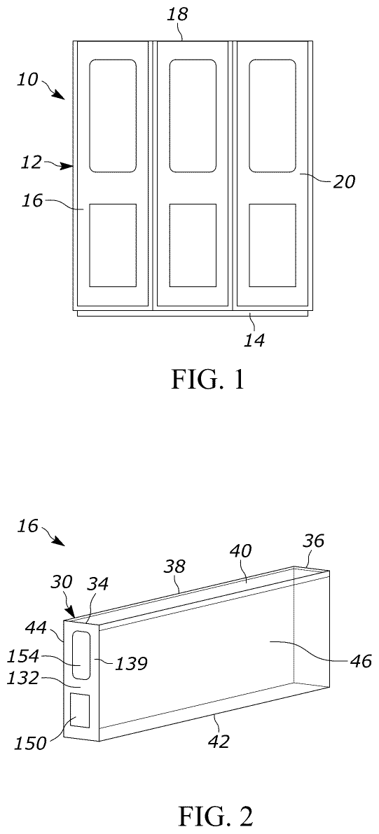

A battery assembly, in accordance with the present disclosure, is indicated generally at 10 in FIG. 1. Battery assembly 10 includes a plurality of batteries 12 supported on a cold plate 14. Heat generated within each of the plurality of batteries 12 passes into cold plate 14 through a system of thermal conduction as will be detailed more fully herein. Plurality of batteries 12 includes a first battery 16, a second battery 18, and a third battery 20. The number and arrangement of the plurality of batteries 12 in battery assembly 10 may vary.

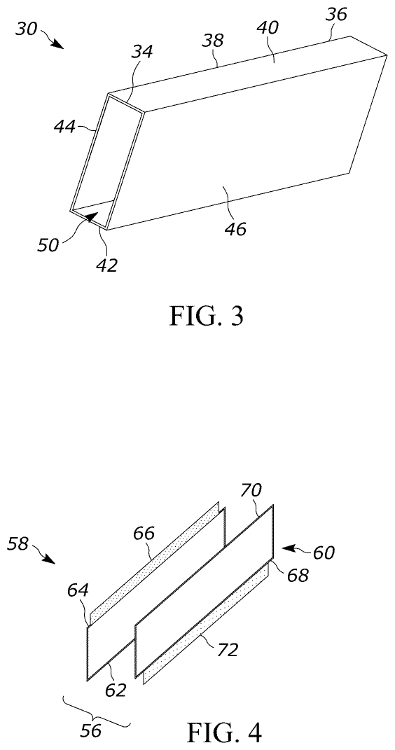

Reference will now follow FIGS. 2 and 3 in describing first battery 16 with an understanding that second battery 18 and third battery 20 are similarly formed. Battery 16 includes a prismatic cell can 30 which, in accordance with the present disclosure, is formed from steel. Prismatic cell can 30 includes a first end 34, a second end 36, and an intermediate portion 38. Intermediate portion 38 extends between first end 34 and second end 36. Prismatic cell can 30 also includes a top surface 40, a bottom surface 42, a first side surface 44, and a second side surface 46. Top surface 40, bottom surface 42, first side surface 44 and second side surface 46 collectively define an electrode stack receiving cavity 50.

An electrode stack 56 that is arranged in hollow can cavity 50 is shown in FIG. 4. Electrode stack 56 includes an anode current collector 58 and a cathode current collector 60. The number each of the anode current collector 58 and cathode current collector 60 for each battery 16 may vary and could depend on desired power characteristics for the battery assembly 10. That is, anode current collector 58 and cathode current collector 60 are provided in pairs. The number of pairs may vary between a single pair, i.e., a single anode current collector and a single electrode current collector with a separator arranged therebetween, to multiple pairs depending on battery power requirements. Anode current collector 58 includes a top surface portion 62 and a bottom surface portion 64. Bottom surface portion 64 is notched to form an anode foil tab 66. Cathode current collector 60 includes a top surface section 68 and a bottom surface section 70. Top surface section 68 is notched to form a cathode foil tab 72.

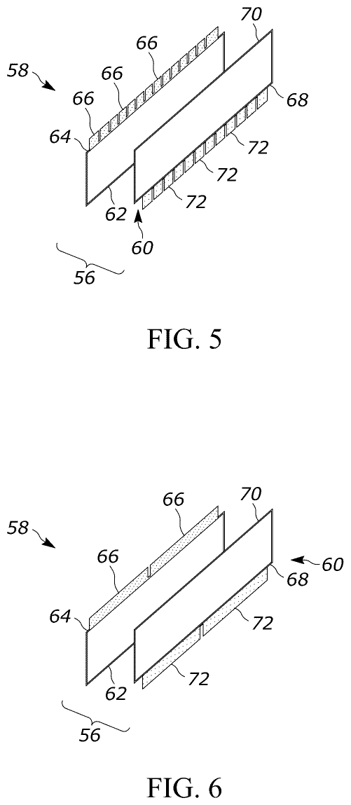

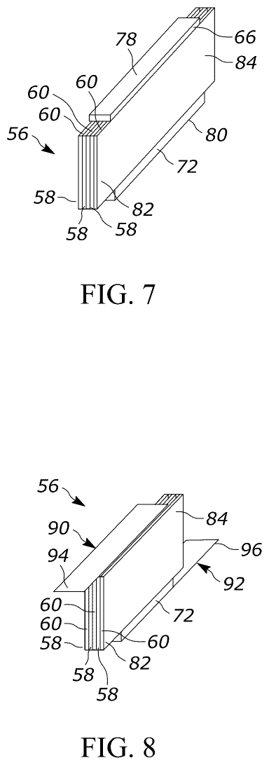

At this point, it should be understood that the number and size of each anode foil tab 66 and each cathode foil tab 72 may vary. For example, anode current collector 58 and cathode current collector 60 may each be notched to form twelve foil tabs such as shown in FIG. 5. Anode current collector 58 and cathode current collector 60 may also be notched to include two foil tabs such as shown in FIG. 6. The number and arrangement of foil tabs may depend on the number of current collectors that form battery stack 56. As the foil tabs are folded over as shown in FIG. 7 to form an anode connection surface 78 and a cathode connection surface 80, battery stacks having a large number of current collectors may include more foil tabs than those which include fewer current collectors. Anode connection surface 78 and cathode connection surface 80 extend between a first end portion 82 and a second end portion 84 of battery stack 56.

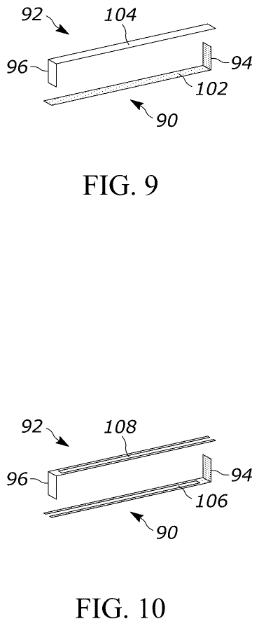

Referring to FIG. 8, an anode terminal lead 90 is connected to anode connection surface 78 and a cathode terminal lead 92 is connected to cathode connection surface 80. Anode terminal lead includes a first terminal end 94 and cathode terminal lead 92 includes a second terminal end 96. Anode terminal lead 90 is formed from copper and cathode terminal lead 92 is formed from aluminum. The particular shape of anode terminal lead 90 and cathode terminal lead 92 may vary. For example, as shown in FIG. 9, anode terminal lead 90 includes a first continuous surface 102 that acts as an interface with anode connection surface 78. Cathode terminal lead 92 includes a second continuous surface 104 that acts as an interface with cathode connection surface 80.

In other examples such as shown in FIG. 10, anode terminal lead 90 may include first slot 106 and cathode terminal lead 92 may include a second slot 108. Anode foil tabs 66 may pass through first slot 102 and be folded before being connected to anode terminal lead 90. Likewise, cathode foil tabs 68 may pass through second slot 108 and be folded before being connected to cathode terminal lead 92. First slot 106 and second slot 108 may be open ended as shown, or they may terminate within respective ones of anode terminal lead 90 and cathode terminal lead 92.

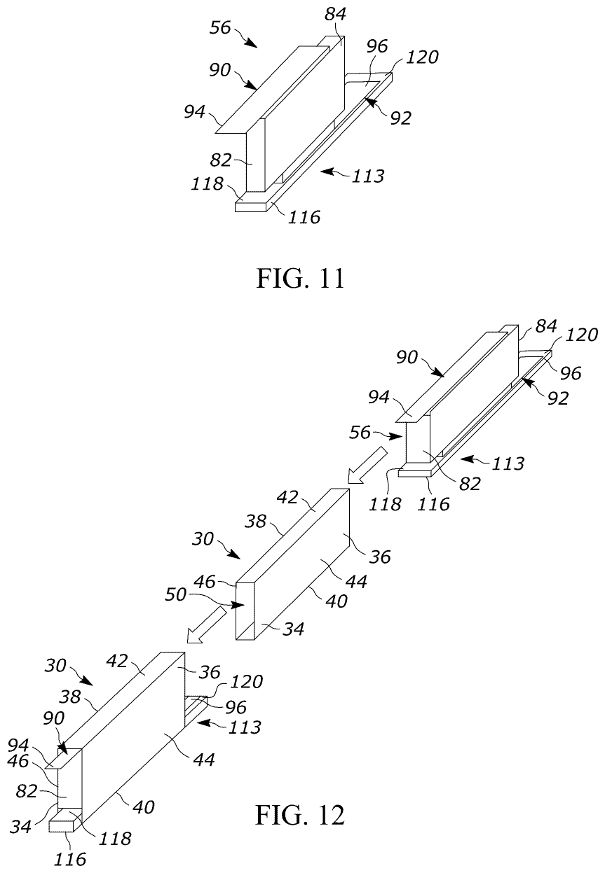

After attaching anode terminal lead 90 and cathode terminal lead 92, electrode stack 56 is positioned on an insertion fixture 113 as shown in FIG. 11. Insertion fixture 113 may take the form of a tray 116 that guides electrode stack 56 into electrode stack receiving cavity 50 such that anode terminal lead 90 does not contact surfaces of prismatic cell can 30 during insertion. Tray 1 is formed having a selected thickness. The thickness is selected to ensure that, when electrode stack 56 is inserted into electrode stack receiving cavity 50, anode terminal lead 90 is in contact with bottom surface 42 of prismatic cell can 30. As shown in FIG. 12, electrode stack 56 is guided into electrode stack receiving zone 50 supported on tray 116. Tray 116 includes a first end section 118 and a second end section 120.

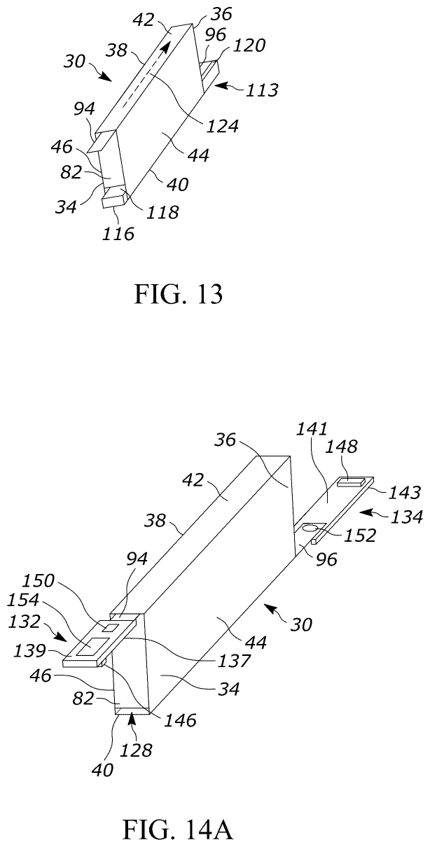

Electrode stack 56 is inserted into electrode stack receiving zone 50 such that first end section 118 of tray 116 projects outwardly of first end 34 and second end section 120 projects outwardly of second end 36. Once in place, first end section 118 and second end section 120 are held in place, such as by clamps (not shown) while pressure is applied to bottom surface 42. The pressure on bottom surface 42 eliminates or reduces air gaps to promote a more solid connection with anode terminal lead 90. Once the air gaps are eliminated, anode terminal lead 90 is joined to bottom surface 42 through a weld 124 as shown in FIG. 13. At this point, it should be understood that other joining techniques, such as the use of thermally conductive adhesive, may also be employed. In a non-limiting example, weld 124 is formed through a laser welding process designed to join copper and steel. After welding anode terminal lead 90 to bottom surface 42, prismatic cell can 30 may be inverted and tray 116 is removed leaving behind a gap 128 between cathode terminal lead 92 and top surface 40 of prismatic cell can 30.

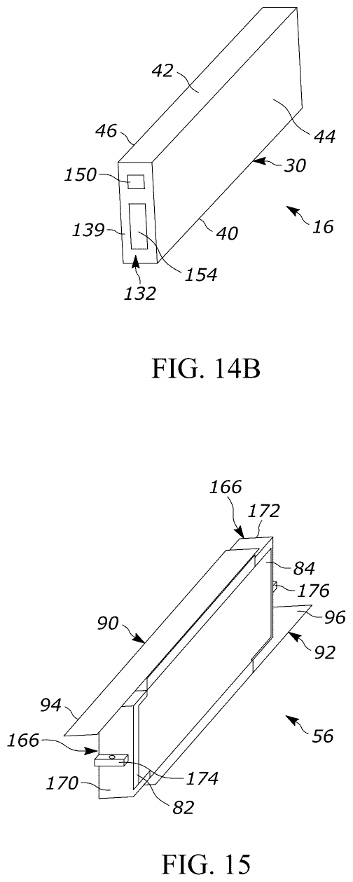

A first cap plate 132 is connected to first terminal end 94 of anode terminal lead 90 and a second cap plate 134 is connected to second terminal end 96 of cathode terminal lead 92 as shown in FIG. 14A. First cap plate 132 may be joined to first terminal end 94 through brazing, soldering, welding or the like. Similarly, second cap plate 134 may be joined to second terminal end 96 through brazing, soldering, welding or the like. First cap plate 132 includes a first inner surface 137 and a first outer surface 139. Second cap plate 137 includes a second inner surface 141 and a second outer surface 143.

First inner surface 137 supports a first fin 146 and second inner surface 141 supports a second fin 148. When first cap plate 132 and second cap plate 134 are installed, such as shown in FIG. 14B first fin 146 contacts first end portion 82 of electrode stack 56 and second fin 148 contacts second end portion 84 of electrode stack 56. In this manner, electrode stack 56 is firmly held in place in electrode stack receiving zone 50. First cap plate 132 includes a first terminal connected to anode terminal lead 90 and second cap plate 134 includes a second terminal 152 connected to cathode terminal lead 92. First terminal 150 and second terminal 152 provide external connection points for battery 16. In addition to supporting first terminal 150, first cap plate 132 supports a vent 154 that selectively opens to connect electrode stack receiving zone 50 with ambient if internal module pressure exceeds a selected pressure threshold.

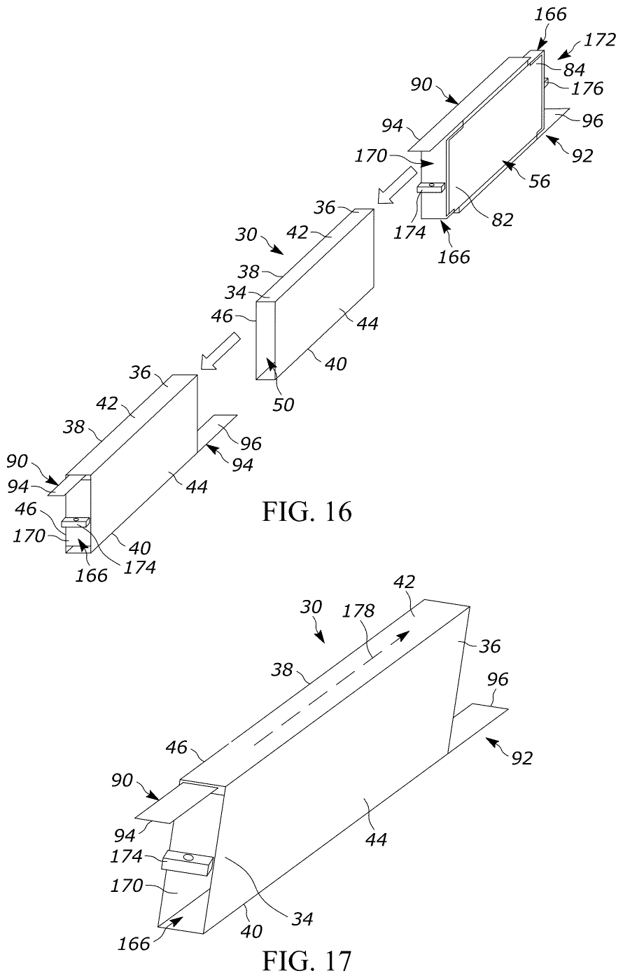

Reference will now follow FIGS. 15 and 16 in describing an insertion fixture 166 in accordance with another non-limiting example. Insertion fixture 166 includes a first U-shaped end cap 170 that is fitted over first end portion 82 of electrode stack 56 and a second U-shaped cap 172 that is fitted over second end portion 84 of electrode stack 56. First U-shaped end cap 170 has a first projection member 174 and second U-shaped end cap 172 includes a second projection member 176. First U-shaped end cap 170 and second U-shaped end cap 172 establish the selected position of electrode stack 56 in electrode stack receiving zone 50 when inserted into prismatic cell can 30 shown in FIG. 16. First U-shaped end cap 170 and second U-shaped end cap 172 are held in place by, for example, applying a clamping pressure to respective ones of first projection member 174 and second projection member 176. At this point, pressure is applied to prismatic cell can 30 causing bottom surface 42 to eliminate or reduce any air gaps that may exist to promote a solid connection with anode terminal lead 90. Once in position, a weld 178 is used to join anode terminal lead 90 to bottom surface 42 as shown in FIG. 17. As discussed herein, other joining techniques, such as the use of thermally conducted adhesive may also be employed. At this point, first and second end caps 132 and 134 may be installed as discussed herein.

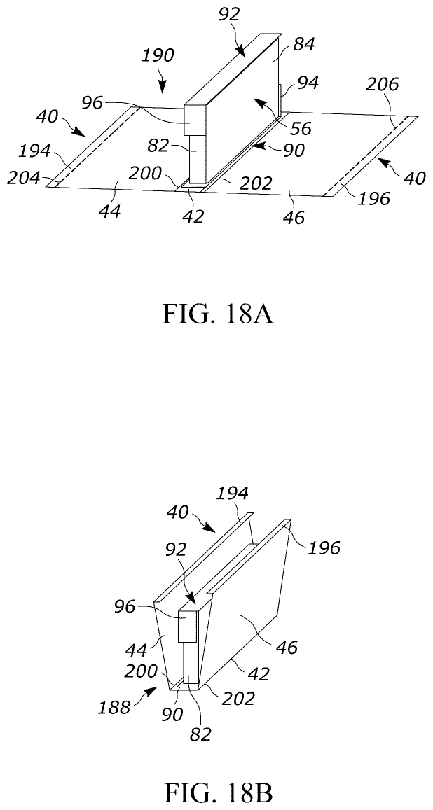

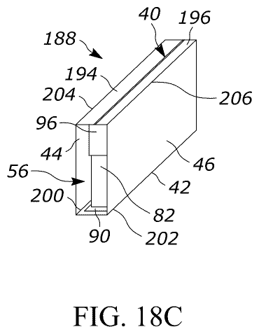

Reference will now follow FIGS. 18A, 18B, and 18C in describing a prismatic cell can 188. A cell can form 190 that is shown as a substantially planar member in FIG. 18A includes top surface 40, bottom surface 42, first side surface 44, and second side surface 46. Tops surface 40 includes a first top surface portion 194 that is part of first side surface 44 and a second top surface portion 196 that is part of second side surface 46. Bottom surface 42 is defined between a first fold line 200 and a second fold line 202. First side surface 44 is defined between first fold line 200 and a third fold line 204 and second side surface 46 is defined between second fold line 202 and a fourth fold line 206.

Anode terminal member 90 is welded to bottom surface 42. After attaching electrode stack 56, cell can form 190 is folded. More specifically, first side surface 44 is folded about first fold like 200 and second side surface 46 is folded about second fold line 202 as shown in FIG. 18B. First top surface portion 194 is folded about third fold line 204 and second top surface portion 196 is folded about fourth fold line 206. At this point, first top surface potion 194 is joined to second top surface portion 196 as shown in FIG. 18C. First top surface portion 194 and second top surface portion 196 may be joined through various metal joining techniques including welding, crimping, and the like. At this point, first and second cap plates 132 and 134 may be installed in a manner similar to that discussed herein.

By securing the anode terminal lead directly to the bottom surface of the prismatic cell can, heat dissipation is greatly improved. Heat will flow from the electrode stack directly into the bottom surface. With this configuration, additional materials, including steel, are now available for use in forming the prismatic cell can. That is, by eliminating any gaps between the anode terminal lead and the bottom surface of the prismatic cell can and creating a direct heat transfer path, materials having a lower thermal conductivity than aluminum are now available. Steel provides a desirable option given its higher melting point, greater strength, and stiffness. The higher melting point means the prismatic can is less likely to fail if exposed to a thermal run-away condition.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is

1. A battery comprising:
a prismatic cell can formed from steel, the prismatic cell can including a first end, a second end spaced from the first end, a top surface, a bottom surface, a first side surface, and a second side surface, the top surface, bottom surface, first side surface and the second side surface defining a hollow can cavity;
an anode current collector arranged in the hollow can cavity, the anode current collector including a top surface portion, a bottom surface portion, and an anode foil tab projecting outwardly from one of the top surface portion and the bottom surface portion;
a cathode current collector arranged in the hollow can cavity, the cathode current collector including a top surface section, a bottom surface section, and a cathode foil tab projecting outwardly from one of the top surface section and the bottom surface section;
an anode terminal lead extending over the one of the top surface portion and the bottom surface portion of the anode current collector, the anode terminal lead being secured to the anode foil tab; and
a cathode terminal lead extending the one of the top surface section and the bottom surface section of the cathode current collector, the cathode terminal lead being secured to the cathode foil tab,
wherein the anode current collector and the cathode current collector form an electrode stack arranged in the hollow can cavity with the anode terminal lead being connected to the bottom surface of the prismatic cell can forming a direct thermal pathway through the electrode stack to the bottom surface.

2. The battery according to claim 1, further comprising: a first cap plate mounted at the first end of the prismatic cell can and a second cap plate mounted at the second end of the prismatic cell can.

3. The battery according to claim 2, wherein the anode terminal lead is electrically secured to the first cap plate and the cathode terminal lead is electrically secured to the second cap plate.

4. The battery according to claim 3, further comprising: a vent formed in one of the first cap plate and the second cap plate.

5. The battery according to claim 3, further comprising a first fin formed on the first cap plate and a second fin formed on the second cap plate, the first fin engaging the electrode stack at the first end of the prismatic cell can and the second fin engaging the electrode stack at the second end of the prismatic cell can.

6. The battery according to claim 1, wherein the electrode stack includes a plurality of anode current collectors and a plurality of anode foil tabs and a plurality of cathode current collectors and a plurality of a cathode foil tabs.

7. The battery according to claim 1, wherein the anode current collector includes a plurality of anode foil tabs, and the cathode current collector includes a plurality of cathode foil tabs.

8. A method of forming a battery comprising:
forming a prismatic cell can from steel including a first end, a second end spaced from the first end, a top surface, a bottom surface, a first side surface, and a second side surface, the top surface, bottom surface, first side surface and the second side surface defining a hollow can cavity;
forming an electrode stack including an anode current collector having a top surface portion and a bottoms surface portion and a cathode current collector having a top surface section and a bottom surface section;
folding an anode foil tab over one of the top surface portion and the bottoms surface portion;
folding a cathode foil tab over one of the top surface section and the bottom surface section;
connecting an anode terminal lead to the anode foil tab, the anode terminal lead extending over the one of the top surface portion and the bottom surface portion;
connecting a cathode terminal lead to the cathode foil tab, the cathode terminal lead extending over the one of the top surface section and the bottom surface section;
inserting the electrode stack into the hollow can cavity with the anode terminal lead being in electrical contact with the bottom surface; and
connecting the anode terminal lead to the bottom surface creating a direct thermal pathway through the electrode stack to the bottom surface.

9. The method of claim 8, further comprising: connecting a first cap plate to the anode terminal lead and connecting a second cap plate to the cathode terminal lead.

10. The method of claim 9, further comprising: securing the first cap plate to the first end of the prismatic cell can and the second cap plate to the second end of the prismatic cell can.

11. The method of claim 8, further comprising: maintaining a gap between the top surface of the prismatic cell can and the top surface portion of the anode current collector and the top surface section of the cathode current collector.

12. The method of claim 8, further comprising: supporting the electrode stack on an insertion fixture.

13. The method of claim 12, wherein inserting the electrode stack into the hollow can cavity includes sliding the insertion fixture along the top surface of the prismatic cell can with the anode terminal lead.

14. The method of claim 13, wherein connecting the anode terminal lead to the bottom surface of the prismatic can cell includes removing an air gap between the bottom surface and the anode terminal lead with the electrode stack supported on the insertion fixture.

15. The method of claim 14, further comprising: removing the insertion fixture from the prismatic cell can after welding the anode terminal to the bottom surface.

16. The method of claim 12, wherein supporting the electrode stack on the insertion fixture includes resting the electrode stack on a tray having a selected thickness.

17. The method of claim 12, wherein supporting the electrode stack on the insertion fixture includes mounting a first U-shaped end cap to a first end of the electrode stack and mounting a second U-shaped end cap to a second end of the electrode stack.

18. The method of claim 8, wherein inserting the electrode stack into the hollow can cavity includes forming a prismatic cell can form about the electrode stack to form the prismatic cell can.

19. The method of claim 18, wherein forming the prismatic cell can form about the electrode stack includes connecting the anode terminal lead to a surface of a prismatic cell can form.

20. The method of claim 19, wherein forming the prismatic cell can form about the electrode stack includes folding a first side of the prismatic cell can form to the first side surface and a first portion of the top surface and folding a second side of the prismatic cell can form to form the second side surface and a second portion of the top surface.
